(19) United States
(12) Patent Application Publication
(10) Pub. No.: US 2026/0031759 A1
(43) Pub. Date: Jan. 29, 2026

(54) PIN FASTENERS FOR SOLAR TRACKING SYSTEMS

(71) Applicant: Nextracker LLC, Fremont, CA (US)

(72) Inventors: Adnan Bedri, Fremont, CA (US); Ricardo Delgado-Nanez, San Jose, CA (US)

(21) Appl. No.: 19/279,470

(22) Filed: Jul. 24, 2025

Related U.S. Application Data
(60) Provisional application No. 63/675,160, filed on Jul. 24, 2024.

(51) Int. Cl. H02S 30/10

(52) U.S. Cl. CPC H02S 30/10

(57) ABSTRACT

A pin fastener includes a body extending along a longitudinal axis, the body having a first side, a second side, a first end region, a second end region, and a central region therebetween. A first angular projection is positioned adjacent the central region of the body and extending away from the longitudinal axis, a stop is positioned adjacent the second end region. The first end region has a first width and a first height, and the second end region has a second width and a second height, and the first width is smaller than the second width and the first height is smaller than the second height.

### RELATED APPLICATIONS

This application claims the benefit of U.S. Provisional Patent Application No. 63/675,160, filed Jul. 24, 2024, the entire contents of which are incorporated herein by reference.

### TECHNICAL FIELD

This disclosure relates generally to device, system, and method embodiments of solar module frames, solar tracker systems, and solar module frame installation. Solar module frame related embodiments disclosed herein can be configured to facilitate more efficient installation of one or more solar modules to a support structure, such as pin fasteners for a solar tracker system.

### BACKGROUND

Solar modules can convert sunlight into energy using photovoltaic cells. Solar tracking systems can support a plurality of solar modules and function to rotate these solar modules amongst a variety of different angular orientations throughout a given day to optimize a solar irradiance angle and, thereby, optimize energy generation at the solar modules.

A conventional solar tracking system includes a plurality of components assembled and installed on site in the field at the location where the solar tracking system is to operate. Typical solar tracking system arrangements may include a plurality of solar modules positioned side by side in an array. Each solar module may be mounted to a rail system including at least a ground support structure and/or a roof-based support structure, by a bracket system. The assembly process can be physically challenging and time-consuming as the space in which an installer has to work to couple the solar module to the rail system is typically narrow and may be tough to access. Solar tracking system component installation utilizes manual labor on site in the field. For example, typical solar tracking system component installation utilizes manual labor to install rails at a torque tube for supporting one or more solar modules at the torque tube followed by additional manual labor to then install solar modules at the installed rails at the torque tube. This typically requires a high degree of tedious manual labor to both place and secure the rails at the torque tube and to then place and secure the solar modules at the installed rails. Moreover, oftentimes solar tracking systems are installed in relatively remote locations and thus installation necessitates costs associated with bringing manual labor to the relatively remote site to execute manual installation over what can be a significant period of time. As such, there remains a continuing need for improved coupling members and more efficient methods for mounting solar modules to support structures.

### SUMMARY

In general, the present disclosure relates to pin fasteners for securing solar arrays within a solar tracking system. In one example, a pin fastener may include a body extending along a longitudinal axis, the body having a first side, a second side, a first end region, a second end region, and a central region therebetween. A first angular projection may be positioned adjacent the central region of the body and extending away from the longitudinal axis, a stop may be positioned adjacent the second end region, and the first end region may have a first width and a first height, and the second end region may have a second width and a second height, and the first width is smaller than the second width and the first height is smaller than the second height.

Additionally or alternatively, the body may include a first fold forming the first side and a second fold forming the second side, the second side opposite the first side.

Additionally or alternatively, the first fold may extend towards the longitudinal axis of the body and the second fold may extend towards the longitudinal axis of the body, such that a channel is formed between the first fold and the second fold.

Additionally or alternatively, the first angular projection may extend away from the body at an angle of about 14° to about 15°.

Additionally or alternatively, the first angular projection may be formed by cutting the body along a portion of one of the first fold or the second fold such that a first end of the first projection remains attached to the body.

Additionally or alternatively, the pin fastener may be formed from a single piece of sheet metal.

Additionally or alternatively, a second angular projection may be positioned adjacent the central region of the body and may extend away from the longitudinal axis in a direction opposite the first angular projection.

Additionally or alternatively, the stop may be formed by folding a base of the body of the pin fastener at the second end of the body such that the fold extends back towards the central region of the body, and the stop may be located offset from a base of the body.

Additionally or alternatively, the central region may have a third height, and the first height may be smaller than the second height and the third height.

Additionally or alternatively, the second height may be the same as the third height.

Additionally or alternatively, the first angular projection and the second angular projection may be inwardly deflectable to the second width of the body when a force is applied and the first angular projection and the second angular projection may return to their original position upon removal of the force.

In another example, a pin fastener may include a body extending along a longitudinal axis, the body having a first side, a second side, a first end region, a second end region, and a central region therebetween. A first angular projection may be positioned adjacent the central region of the body and extending away from the longitudinal axis, a second angular projection may be positioned adjacent the central region of the body and extending away from the longitudinal axis in a direction opposite the first angular projection, a stop may be positioned adjacent the second end region, and the first end region may have a narrowed width and a shorter height than the central region to facilitate insertion into a first opening of a first element, a first opening of a second element, a second opening of the first element, and a second opening of the second element.

Additionally or alternatively, the first end region may have a first height, the second end region may have a second height, the central region may have a third height, and the first height may be smaller than the second height and the third height.

Additionally or alternatively, the first angular projection and the second angular projection may be inwardly deflectable to a width of the body when a force is applied and the first angular projection and the second angular projection may return to their original position upon removal of the force.

Additionally or alternatively, a distance from the first angular projection and second angular projections to an end of the stop may correspond with a distance between the first opening and the second opening of the first element.

In a further example, a method of securing a first element to a second element may include providing a pin fastener and the pin fastener may include, a body extending along a longitudinal axis, the body having a first side, a second side, a first end region, a second end region, and a central region therebetween. A first angular projection may be positioned adjacent the central region of the body and extending away from the longitudinal axis, a second angular projection may be positioned adjacent the central region of the body and extending away from the longitudinal axis in a direction opposite the first angular projection, and a stop may be positioned adjacent the second end region. The method may further include inserting the pin fastener through a first opening of the first element, a first opening of the second element, a second opening of the first element, and a second opening of the second element; and the first angular projection and the second angular projection are inwardly deflectable to a width of the body when a force is applied, and the first angular projection and the second angular projection may return to their original position upon removal of the force.

Additionally or alternatively, the stop may engage with the first element adjacent to the first opening of the first element to prevent further insertion of the pin fastener.

Additionally or alternatively, the first end region may have a narrowed width and a shorter height than the central region to facilitate insertion into the first opening of the first element, the first opening of the second element, the second opening of the first element, and the second opening of the second element to facilitate alignment of the first opening of the first element, the first opening of the second element, the second opening of the first element, and the second opening of the second element as the pin fastener is inserted.

Additionally or alternatively, the stop may be formed by folding a base of the body of the pin fastener at the second end of the body such that the fold extends back towards the central region of the body, and the stop may be located offset from a base of the body.

Additionally or alternatively, the first element may be a torque tube mount and the second element may be a rail.

The details of one or more examples are set forth in the accompanying drawings and the description below. Other features, objects, and advantages will be apparent from the description and drawings, and from the claims.

### BRIEF DESCRIPTION OF DRAWINGS

The following drawings are illustrative of particular embodiments of the present disclosure and, therefore, do not limit the scope of the disclosure. The drawings are intended for use in conjunction with the explanations in the following description. Embodiments of the disclosure will hereinafter be described in conjunction with the appended drawings, wherein like numerals denote like elements. The features illustrated in the drawings are not necessarily to scale, though embodiments within the scope of the present disclosure can include one or more of the illustrated features at the scale shown. Various aspects and features of the present disclosure are described hereinbelow with reference to the drawings, wherein:

FIG. 1 is a schematic, perspective view of a solar tracker apparatus;

FIG. 2A is a schematic, first view of a solar module coupling system;

FIG. 2B is a schematic, second view of the solar module coupling system of FIG. 2A;

FIG. 3A is a schematic, perspective view of a pin fastener, in accordance with the disclosure;

FIG. 3B is a schematic, top view of the pin fastener as in FIG. 3A;

FIG. 3C is a schematic, side view of the pin fastener as in FIG. 3A;

FIG. 3D is a schematic, front view of the pin fastener as in FIG. 3A;

FIG. 3E is a schematic, rear view of the pin fastener as in FIG. 3A;

FIG. 4A is a schematic, side view of the torque tube mount coupled to the rail showing a first end region of the pin fastener;

FIG. 4B is a schematic, side view of the torque tube mount coupled to the rail showing a second end region of the pin fastener;

FIG. 5A is a schematic, rear view of the torque tube mount coupled to the rail using the pin fastener;

FIG. 5B is a schematic, rear view of the torque tube mount coupled to the rail, as in FIG. 5A, with the pin fastener removed;

FIG. 6A is a schematic view of a portion of the torque tube mount and the rail;

FIG. 6B is a schematic view of a portion of the torque tube mount being aligned with the rail;

FIG. 6C is a schematic view of a portion of the torque tube mount coupled to the rail; and

FIG. 7 is a flow chart showing a method of securing a first element to a second element.

### DETAILED DESCRIPTION

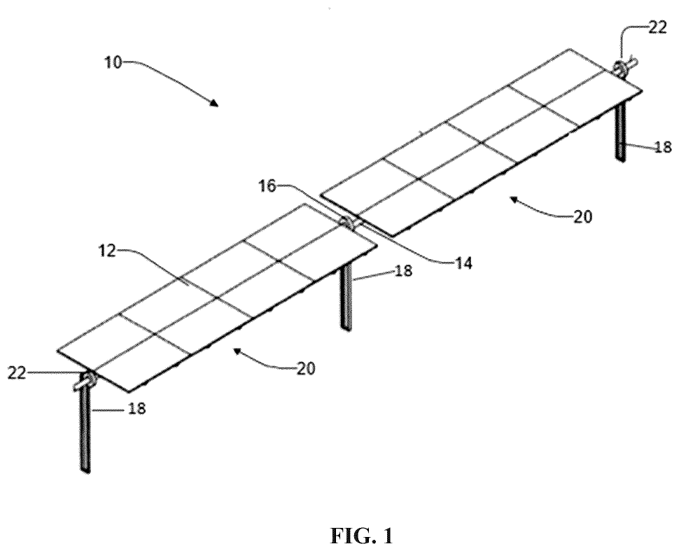

The present disclosure is directed to ground piles for a solar tracking system. FIG. 1 is a perspective view of a common arrangement of a solar tracker 10 provided in accordance with the present disclosure. The solar tracker 10 may be formed of a plurality of bays 20 defined by the distance between ground piles 18 (generally referenced herein as piles 18). FIG. 1 illustrates two bays 20 of the solar tracker 10. However, it will be appreciated that the solar tracker 10 may include four bays, six bays, ten bays, twenty bays, or any other suitable number of bays as desired. At each pile 18 is either a bearing 22 or generally near the center of the solar tracker 10 a drive mechanism 16. Each of the bearings 22 and the drive mechanism 16 are supported by one of the piles 18. Activation of the drive mechanism rotates a torque tube 14 about an axis of rotation and thus rotates one or more solar modules 12 mounted to the torque tube 14 such that the solar modules 12 can be oriented to a desired position. That desired position may be to a position to capture maximum sunlight based on the location of the sun in the sky, that position may be to a 0-angle position during times of diffuse light, the desired position may be a safety position based on weather conditions such as high winds or a snow storm, or any position in between as desired by the operators of the solar power plant in which the solar tracker 10 is located given the current weather and atmospheric conditions, the current demands of the grid, and other factors. The bearings 22 reduce to the extent possible the resistance to movement of the torque tube 14 and the solar modules 12.

The torque tube 14 is sized (e.g., diameter, wall thickness, material) such that sag between the piles 18 is reduced or substantially eliminated and to absorb torsional loads applied to the torque tube 14 by wind loading. In addition, since there is just a single drive mechanism 16, the specifications for the torque tube 14 must also seek to eliminate twist of the torque tube 14 along its length. Any twist would result in the solar modules 12 being oriented differently from what is desired, and thus again reduce the output and efficiency of the solar tracker 10, particularly, as the solar tracker 10 is rotated to the extreme angles of permitted range (e.g., +/−60 degrees or more).

As will be appreciated, the solar modules 12 must be supported on the torque tube 14. This is typically achieved by a bracket system (not shown in FIG. 1) that is attached to the torque tube 14 substantially perpendicular to the longitudinal axis of the torque tube 14. The torque tube 14 may be rotatable about its longitudinal axis to adjust an angular orientation of the solar modules 12 relative to the sun, while supporting the solar modules 12 on the bracket system. The bracket system may take many forms including two pieces of hat shaped steel, which may be arranged to sandwich the solar modules 12, and may be configured to connect to a rail, which is then coupled to the torque tube 14.

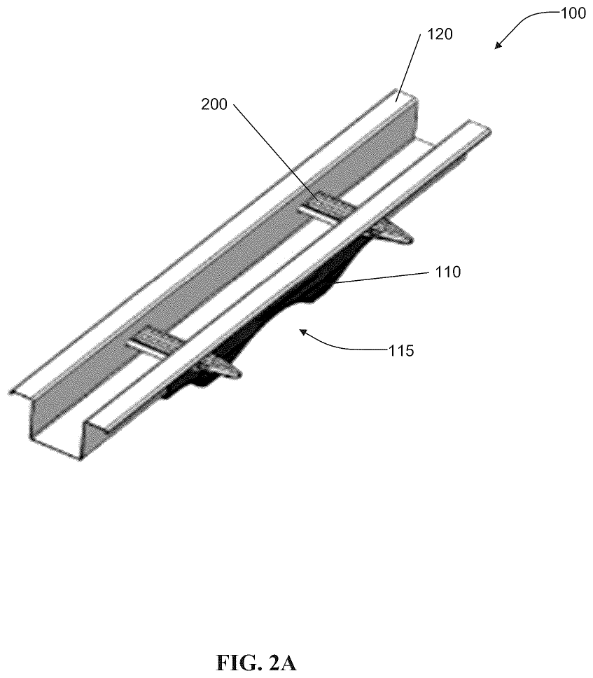

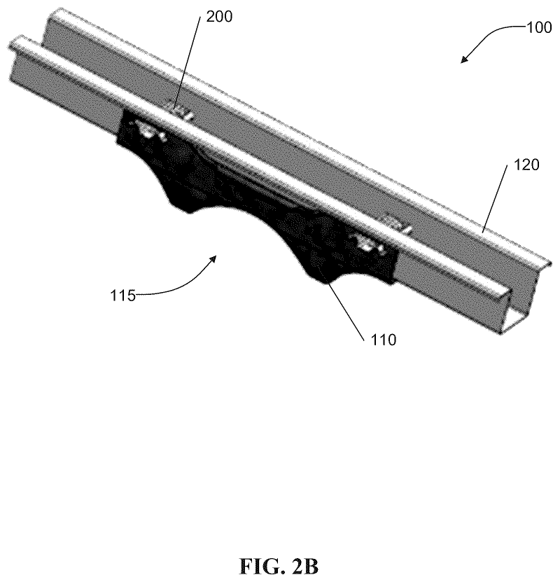

FIGS. 2A and 2B show a solar module coupling system 100 including a torque tube mount 110 coupled to a rail 120 using a pin fastener 200. In some examples, the rail 120 may be a U-channel rail that may be configured to be coupled to a solar module (e.g., solar module 12). The rail 120 may be coupled to a torque tube (e.g., torque tube 14) via the torque tube mount 110. The torque tube mount 110 may include a saddle region 115 configured to receive the torque tube 14. The torque tube mount 110 may be mechanically coupled to the torque tube 14 such that the torque tube mount 110 and the torque tube 14 rotate in unison, which in turn rotates the rail 120, thereby rotating the solar module.

As previously stated, the torque tube 14 is sized to eliminate and absorb torsional loads applied by wind loading, and/or other stresses such as weight, position of the solar module 12, or the like. Further, additional components of the solar tracker system 10 may be subject to the same forces, causing stress to the components, such as, for example, the pin fastener 200. In some cases, excessive forces may cause the pin fastener 200 to jostle, slide, and disengage from its position, which can cause the rail 120 to separate from the torque tube mount 110. Thus, the pin fastener 200 may include features designed to hold the pin fastener 200 in place, preventing the pin fastener 200 from being disengaged from its position, as will be discussed further herein.

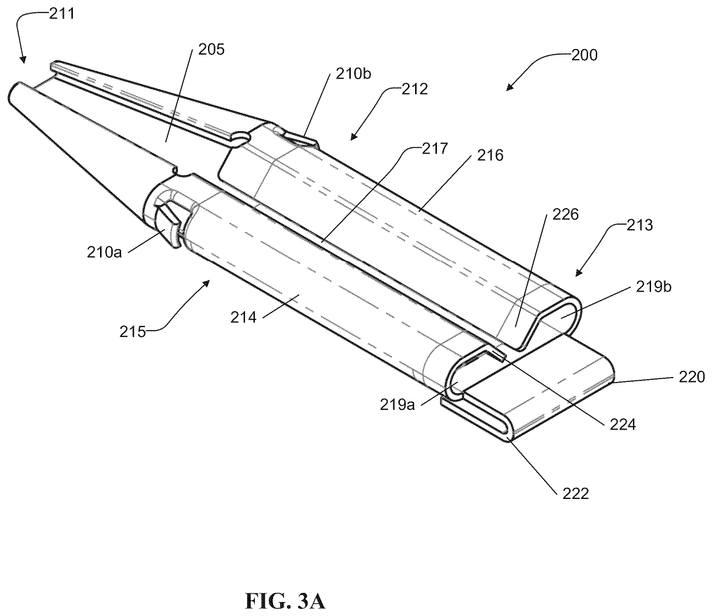

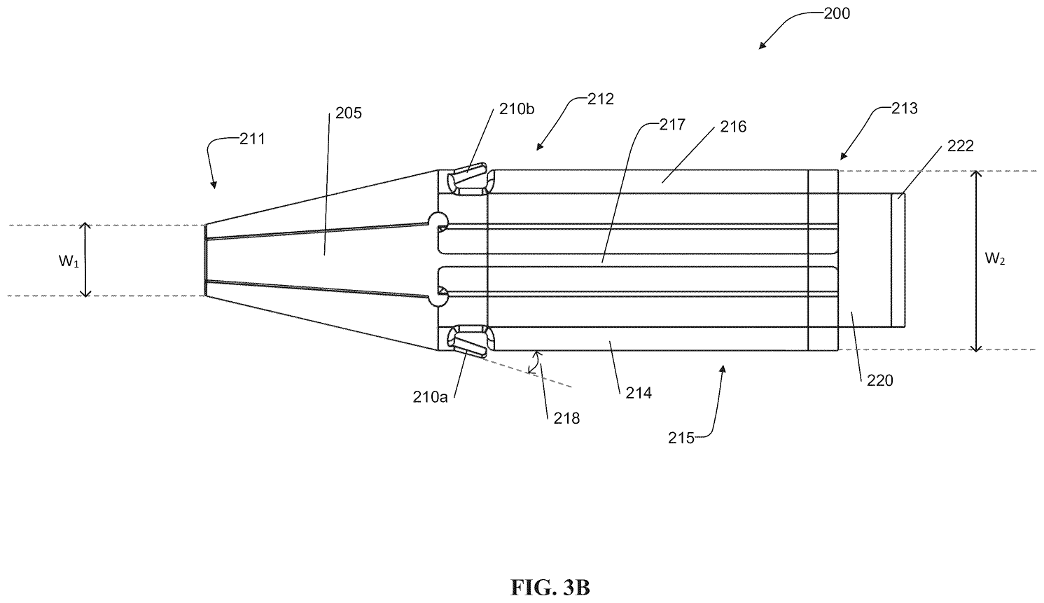

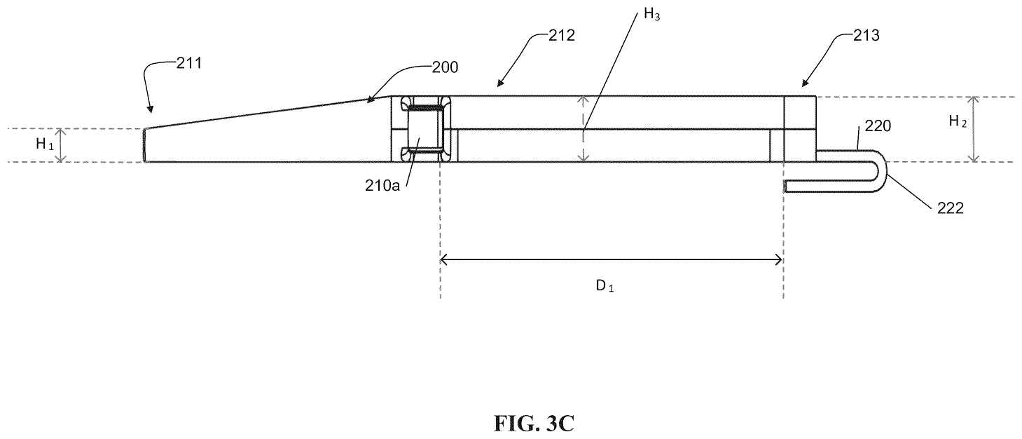

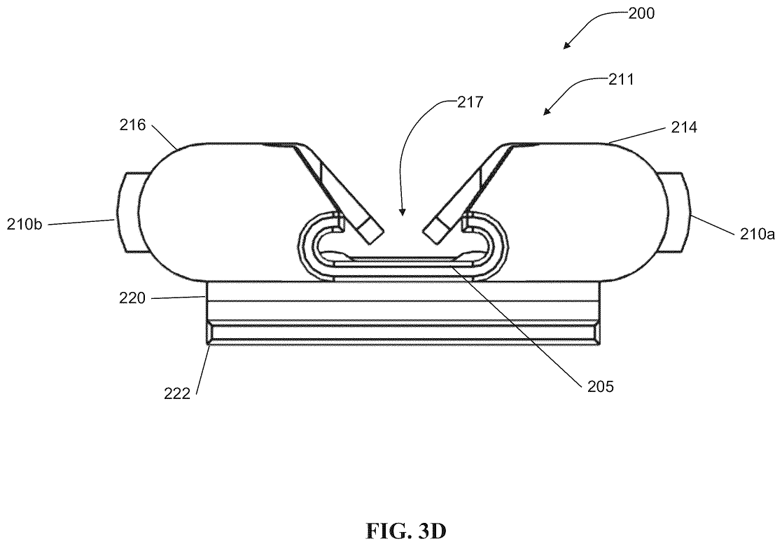

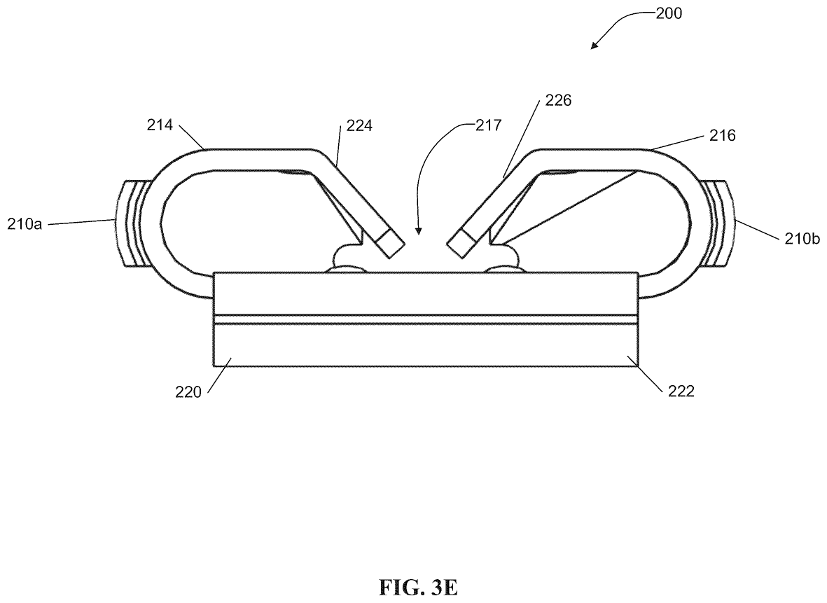

FIGS. 3A to 3E illustrate a pin fastener 200 in accordance with the disclosure. FIG. 3A is a perspective view of the pin fastener 200, FIG. 3B is a top view of the pin fastener 200, FIG. 3C is a side view of the pin fastener 200, FIG. 3D is a front view of the pin fastener 200, and FIG. 3E is a rear view of the pin fastener 200. The pin fastener 200 may include a metal body 215 extending along a longitudinal insertion axis, the body 215 having a first end region 211, a second end region 213, and a central region 212 therebetween.

The body 215 may be formed from a steel such as, for example, carbon steel, alloy steel, tool steel, and/or stainless steel. The steel may be formed from a single piece of sheet metal, cut and folded to form the pin fastener 200. In some cases, the steel may be a cut into a metal strip and formed via a metal forming process, a stamping process, or the like. The metal strip may be cut and folded to form the various features of the pin fastener 200. For example, a first side 214 of the body 215 may be formed from a first fold 219a that extends away from a base 205 of the body 215, curves up and around and extends back towards the longitudinal axis of the body 215. The first side 214 may further include an angled wall 224 that extends downward from the first curve 219a toward the base 205 of the body 215. A second side 216 may be formed from a second fold 219b that extends away from the base 205 of the body 215 in a direction opposite the first side 214, curves up and around and extends back towards the longitudinal axis of the body 215. The second side 216 may further include an angled wall 226 that extends downward from the second curve 219b and toward the base 205 of the body 215. In some cases, the angled walls 224, 226 may not touch one another. In some cases, the angled walls 224, 226 may touch one another. In either case, the angled walls 224, 226 together form a “V” shape, and may form a channel 217 therebetween that runs along the longitudinal insertion axis of the body 215. Such a configuration allows the pin fastener 200 to maintain its strength while also providing flexibility for compression of the pin fastener 200.

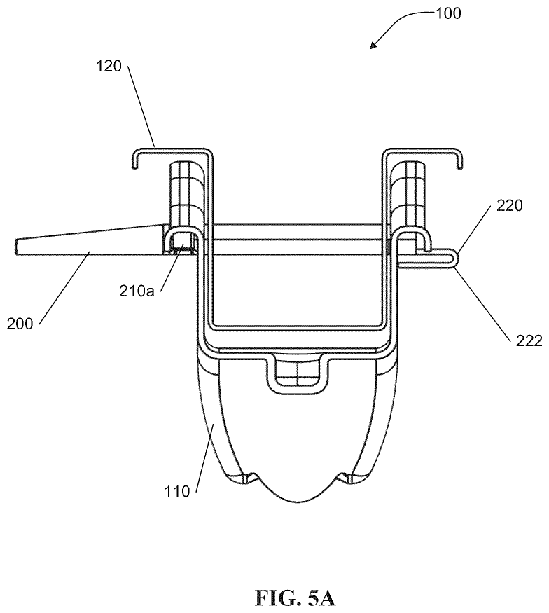

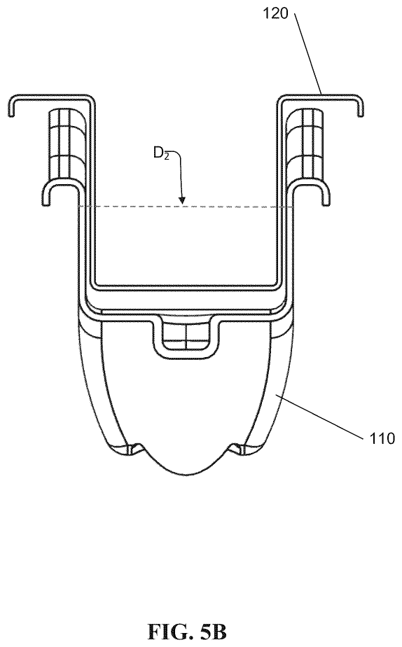

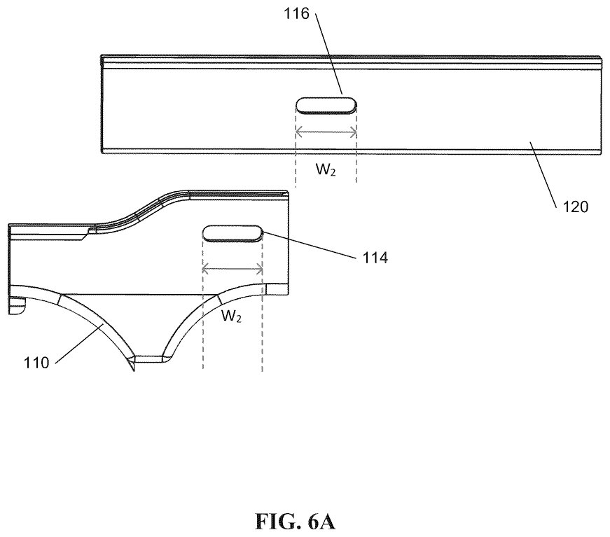

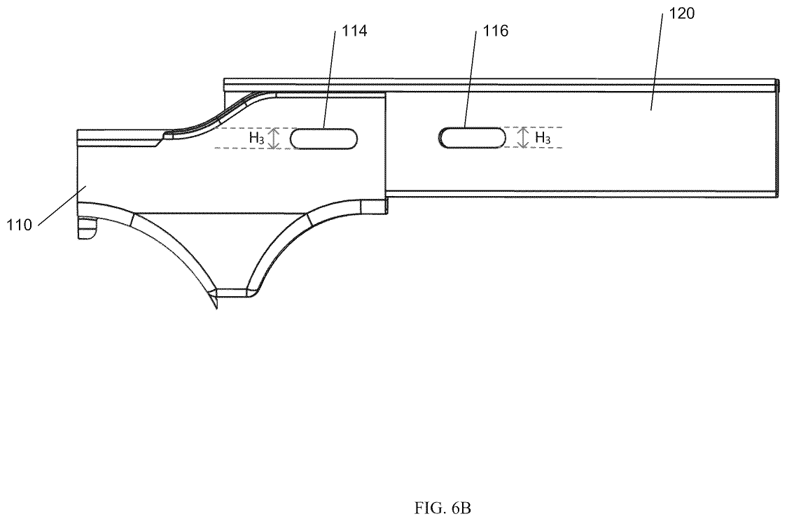

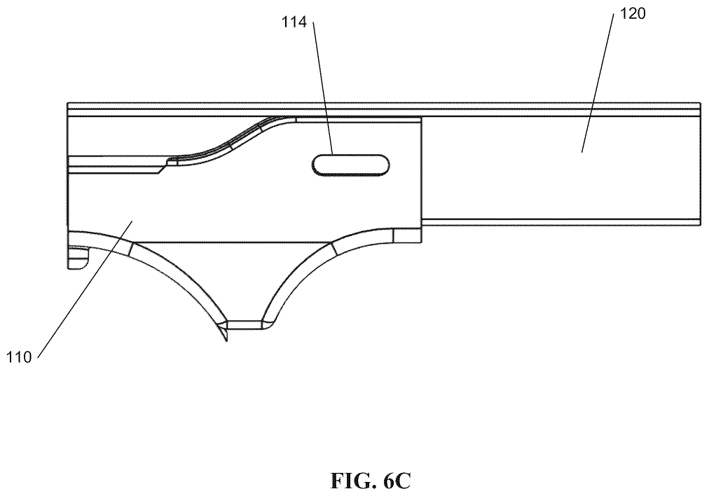

The first end region 211 of the body 215 may be a tapered region. The first end region 211, or tapered region, may assist with insertion of the pin fastener 200 as the pin fastener 200 is inserted into openings within the torque tube mount 110 and the rail 120, as will be discussed further with reference to FIGS. 5A to 7. As shown in FIG. 3B, the first end region 211 may include a first width W1, and the second end region 213 may include a second width W2. The second width W2 may correspond to a width of the openings of the rail 120 and the torque tube mount 110, as shown more clearly in FIG. 6A. As can be seen, the first width W1 may be smaller than the second width W2. Further, as shown in FIG. 3C, the first end region 211 may include a first height H1, the second end region may include a second height H2, and the central region may include a third height H3. As shown, the first end region 211 may include a height H1 that is less than the second height H2 and the third height H3. Further, in some cases, the second height H2 may be the same as the third height H3, but this isn't always necessary. The tapered first end region 211 allows the pin fastener 200 to be more easily positioned during assembly of the solar module coupling system 100. FIG. 3C further shows a distance D1 from the first and second angular projections 210a, 210b to the end of the stop 220. This distance corresponds with the distance between the first opening and the second opening of the torque tube mount 120, as shown in FIG. 5B.

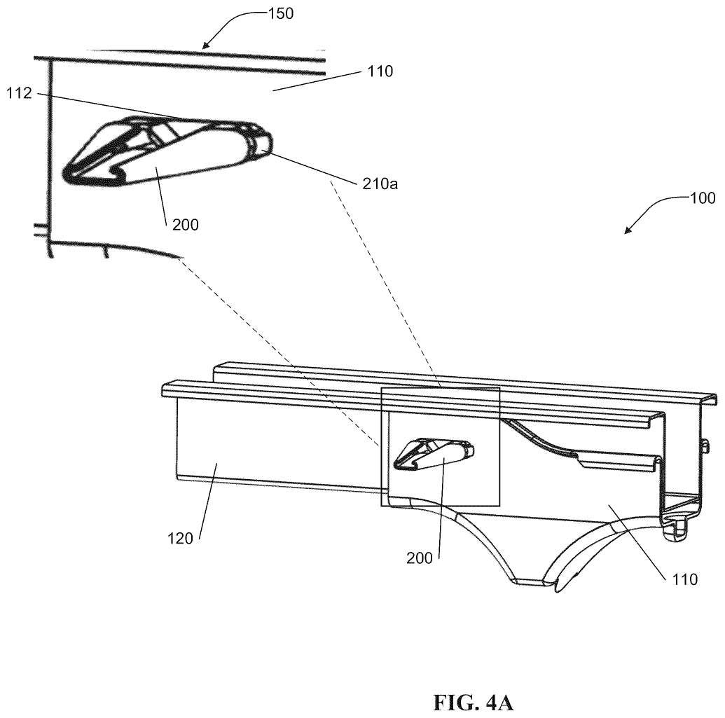

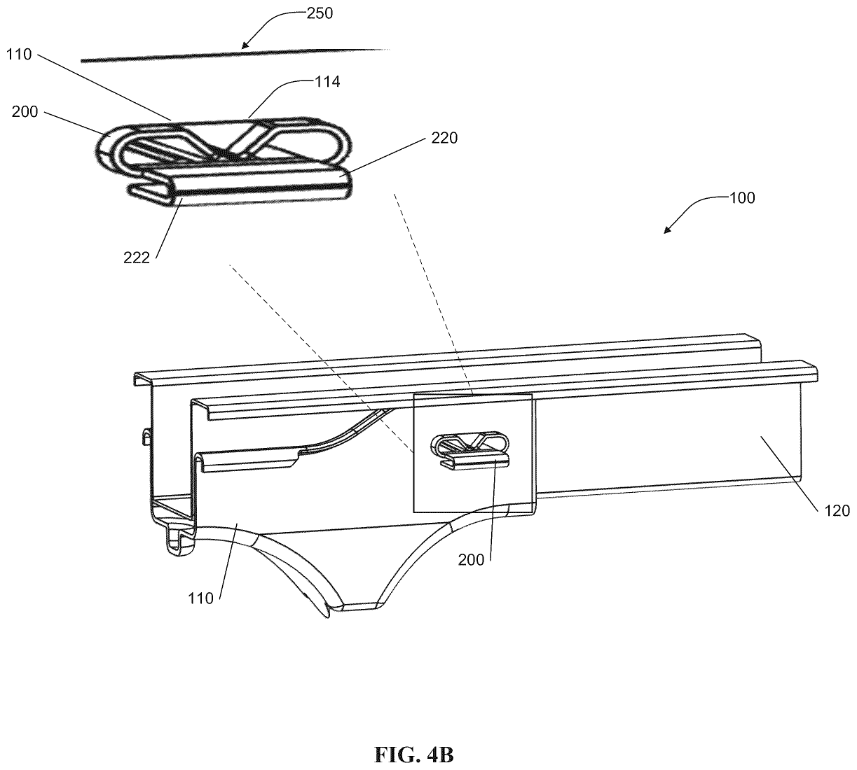

A stop 220 may be positioned at or adjacent to the second end region 213 of the body 215. The stop 220 may be formed via a third fold 222 extending along the longitudinal axis of the body 215 and down and around such that the stop 220 is located offset from the base 205 of the body 215 in a direction opposite the first and second folds 219a, 219b, thereby forming a “U” shape, as shown more clearly in FIG. 3C. The stop 220 may be configured to engage with an outer side of the torque tube mount 110 due to the stop 220 being located offset from 205 in a direction opposition the first and second folds 219a, 219b, thereby preventing further advancement of the pin fastener 200 through openings of the torque tube mount 110 and the 120, as shown in FIGS. 4A and 4B.

As shown in FIG. 3B, the first side 214 of the body 215 may include a first angular projection 210a, and the second side 216 of the body 215 may include a second angular projection 210b. While it is shown that the pin fastener 200 includes two angular projections, it may be contemplated that the pin fastener 200 may include one angular projection, three angular projections, four angular projections, or any number of angular projections as desired. The first angular projection 210a and the second angular projection 210b are inwardly deflectable (e.g., resilient springs), such that may compress inward when being inserted into the openings formed by the rail 120 and the torque tube mount 110. Upon insertion, the first angular projection 210a and the second angular projection 210b may then spring back to the original shape when inserted past the openings to thereby prevent withdrawal from the openings.

The first angular projection 210a and the second angular projection 210b may each be positioned adjacent to the central region 212 of the body 215 opposite one another. While it is shown that the first and second angular projections are positioned adjacent to the central region 212 of the body 215, it may be contemplated that they are positioned at any position along the body 215. For example, adjacent the first end region 211, the second end region 213, or anywhere therebetween.

The first angular projection 210a and the second angular projection 210b each may be formed by cutting a notch into the body 215 along a portion of the first fold 219a (e.g., the first side 214) and/or the second fold 219b (e.g., the second side 216), respectively, such that a first end of each of the first angular projection 210a and the second angular projection 210b remains attached to the body 215 of the pin fastener 200. The first angular projection 210a and the second angular projection 210b may each extend away from the body 215 at an angle 218 of about 12° to about 30°. In some cases, the first angular projection 210a and the second angular projection 210b may each extend away from the body 215 at an angle 218 of about 14° to about 15°. The first angular projection 210a and the second angular projection 210b may be configured to engage with an outer side of the torque tube mount 110, as shown in FIGS. 4A and 4B.

### Using the Pin Fastener

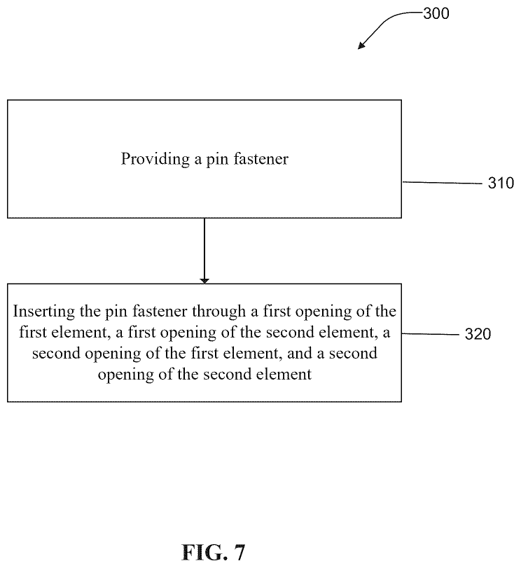

FIGS. 4A and 4B are side views of the solar module coupling system 100 showing the first end region 211 of the pin fastener 200 and the second end region 213 of the pin fastener 200, respectively. FIG. 5A is a rear view of the solar module coupling system 100 using the pin fastener 200, and FIG. 5B is a rear view of the solar module coupling system 100 with the pin fastener 200 removed. FIGS. 6A to 6C are side views illustrating an alignment of first openings and second openings of the torque tube mount 110 and the rail 110, and FIG. 7 is a flow chart showing a method 300 of securing a first element (e.g., the torque tube mount 110) to a second element (e.g., the rail 120).

During use, the rail 120 may be positioned within the torque tube mount 110, in an assembly position. When the rail 110 and the torque tube mount 110 are in the assembly position, a first opening 114 (FIG. 4B) of the torque tube mount 110 is aligned with a first opening (not explicitly shown) of the rail 120 and a second opening 112 (FIG. 4A) of the torque tube mount 110 is aligned with a second opening (not explicitly shown) of the rail 120. The first openings 114, 116 (shown in FIGS. 6A, 6B) further align with the second openings 112. A pin fastener, such as pin fastener 200 may be provided, as referenced by block 310 in FIG. 7. The pin fastener 200 may be aligned with first openings 114 and may be inserted through the first openings 114 along the longitudinal insertion axis of the pin fastener 200. The pin fastener 200 may traverse the longitudinal axis of the torque tube mount 110 and the rail 120 and extend through the second openings 112 of the torque tube mount 110 and the rail 120, as referenced by block 320. As shown in FIGS. 3A to 3C, the first end region 211 has a narrowed width (W1) and a shorter height (H1) than the central region 212 of the body 215 which facilitates insertion into the first openings 114, 116 and the second openings 112 by facilitating alignment of the first openings 114, 116 and the second openings 112 as the pin fastener 200 is inserted therethrough.

The pin fastener 200 may be inserted using an insertion tool, a mallet, or any other tool designed to provide enough force to ensure the angular projections 210a, 210b of the pin fastener 200 pass through both the first openings 114 and the second openings 112. Insertion of the pin fastener 200 will stop when the stop 220 encounters an outer side of the torque tube mount 110, as shown in FIG. 4B. Upon insertion, the angular projections 210a, 210b of the pin fastener 200 may compress inward to pass through both the first openings 114, 116 and the second openings 112. Once the angular projections 210a, 210b have passed through the second openings 112, the compression is released and the angular projections 210a, 210b spring back to an angle that is wider than the first and second openings 114, 112. For example, the angular projections 210a, 210b may compress to a width that corresponds to the second width W2 (FIG. 3B) and release to a width greater than the second width W2. Therefore, when the pin fastener 200 is in place, the angular projections 210a, 210b will engage with an outer side of the torque tube mount 110, as shown in FIG. 4A, and prevent the pin fastener 200 from being removed from the first and second openings 114, 116, 112.

As shown in FIGS. 5A and 5B, the distance D1 between the openings 114, 112 of the torque tube mount 120 corresponds to the distance D1 of the pin fastener 200 between the angular projections 210a, 210b and the end of the stop 220. In this way, the pin fastener 200 is designed to hold the rail 120 and the torque tube mount 120 in a desired position.

FIGS. 6A to 6C illustrate an alignment of the first opening 114 of the torque tube mount 120 with a first opening 116 of the rail 110. As shown in FIG. 6A, the second width W2 (also shown in FIG. 3B) corresponds to the width of the first opening 114 of the torque tube 120, and the first opening 116 of the rail 110. Further, as shown in FIG. 6B, the third height H3 corresponds to the heights of the first opening 114 of the torque tube mount 120 and the first opening 116 of the rail 120. In some cases, the first height H1 may be less than the third height H3 to facilitate insertion into such openings, and the stop 220 extends beyond the third height H3 in order to function as a stop.

Various non-limiting exemplary embodiments have been described. It will be appreciated that suitable alternatives are possible without departing from the scope of the examples described herein.

1. A pin fastener, comprising:
a body extending along a longitudinal axis, the body having a first side, a second side, a first end region, a second end region, and a central region therebetween;
a first angular projection positioned adjacent the central region of the body and extending away from the longitudinal axis;
a stop positioned adjacent the second end region; and
wherein the first end region has a first width and a first height, and the second end region has a second width and a second height, and the first width is smaller than the second width and the first height is smaller than the second height.

2. The pin fastener of claim 1, wherein the body includes a first fold forming the first side and a second fold forming the second side, the second side opposite the first side.

3. The pin fastener of claim 2, wherein the first fold extends towards the longitudinal axis of the body and the second fold extends towards the longitudinal axis of the body, such that a channel is formed between the first fold and the second fold.

4. The pin fastener of claim 1, wherein the first angular projection extends away from the body at an angle of about 14° to about 15°.

5. The pin fastener of claim 2, wherein the first angular projection is formed by cutting the body along a portion of one of the first fold or the second fold such that a first end of the first projection remains attached to the body.

6. The pin fastener of claim 1, wherein the pin fastener is formed from a single piece of sheet metal.

7. The pin fastener of claim 1 further comprising, a second angular projection positioned adjacent the central region of the body and extending away from the longitudinal axis in a direction opposite the first angular projection.

8. The pin fastener of claim 1, wherein the stop is formed by folding a base of the body of the pin fastener at the second end of the body such that the fold extends back towards the central region of the body, and the stop is located offset from a base of the body.

9. The pin fastener of claim 1, wherein the central region has a third height, and the first height is smaller than the second height and the third height.

10. The pin fastener of claim 9, wherein the second height is the same as the third height.

11. The pin fastener of claim 7, wherein the first angular projection and the second angular projection are inwardly deflectable to the second width of the body when a force is applied, and the first angular projection and the second angular projection return to their original position upon removal of the force.

12. A pin fastener, comprising:
a body extending along a longitudinal axis, the body having a first side, a second side, a first end region, a second end region, and a central region therebetween;
a first angular projection positioned adjacent the central region of the body and extending away from the longitudinal axis;
a second angular projection positioned adjacent the central region of the body and extending away from the longitudinal axis in a direction opposite the first angular projection;
a stop positioned adjacent the second end region; and
wherein the first end region has a narrowed width and a shorter height than the central region to facilitate insertion into a first opening of a first element, a first opening of a second element, a second opening of the first element, and a second opening of the second element.

13. The pin fastener of claim 12, wherein the first end region has a first height, the second end region has a second height, the central region has a third height, and the first height is smaller than the second height and the third height.

14. The pin fastener of claim 12, wherein the first angular projection and the second angular projection are inwardly deflectable to a width of the body when a force is applied, and the first angular projection and the second angular projection return to their original position upon removal of the force.

15. The pin fastener of claim 12, wherein a distance from the first angular projection and second angular projections to an end of the stop corresponds with a distance between the first opening and the second opening of the first element.

16. A method of securing a first element to a second element, the method comprising:
providing a pin fastener, the pin fastener comprising:
a body extending along a longitudinal axis, the body having a first side, a second side, a first end region, a second end region, and a central region therebetween;
a first angular projection positioned adjacent the central region of the body and extending away from the longitudinal axis;
a second angular projection positioned adjacent the central region of the body and extending away from the longitudinal axis in a direction opposite the first angular projection; and
a stop positioned adjacent the second end region;
inserting the pin fastener through a first opening of the first element, a first opening of the second element, a second opening of the first element, and a second opening of the second element; and
wherein the first angular projection and the second angular projection are inwardly deflectable to a width of the body when a force is applied, and the first angular projection and the second angular projection return to their original position upon removal of the force.

17. The method of claim 16, wherein the stop engages with the first element adjacent to the first opening of the first element to prevent further insertion of the pin fastener.

18. The method of claim 16, wherein the first end region has a narrowed width and a shorter height than the central region to facilitate insertion into the first opening of the first element, the first opening of the second element, the second opening of the first element, and the second opening of the second element to facilitate alignment of the first opening of the first element, the first opening of the second element, the second opening of the first element, and the second opening of the second element as the pin fastener is inserted.

19. The method of claim 16, wherein the stop is formed by folding a base of the body of the pin fastener at the second end of the body such that the fold extends back towards the central region of the body, and the stop is located offset from a base of the body.

20. The method of claim 16, wherein the first element is a torque tube mount, and the second element is a rail.
